(19) United States
(12) Patent Application Publication
(10) Pub. No.: US 2007/0124260 A1
(43) Pub. Date: May 31, 2007

(54) Method and device for franking postal items

(75) Inventors: Bernd Meyer, Konigswinter (DE); Jurgen Lang, Bergisch Gladbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/586,408

(22) PCT Filed: Dec. 15, 2004
(86) PCT No.: PCT/EP04/14288

§ 371 Date: Jul. 18, 2006

(30) Foreign Application Priority Data
Jan. 20, 2004 (DE) 10 2004 003 004.9

(51) Int. Cl. G06F 17/00

(52) U.S. Cl. 705/404

(57) ABSTRACT

The invention relates to a method for franking postal items. The franking note is prepared on a central system and is then transferred to a client system to be printed out. The franking note is transferred from the central system to the client system in two steps. In a first step, an invalid pre-print of the franking note is transferred and in the second step, the valid franking note is transferred to the central franking system by feeding it back to the central system, said feedback being controlled by the printing process. The invention also relates to a suitable device for carrying out the method.

### BACKGROUND OF THE INVENTION

1. Field of the Invention

The invention relates to a method and device for franking mailpieces, especially letters and parcels, the postage indicium being produced on a central system and transmitted to a customer system in order to be printed.

2. Description of Related Art

It is known that franking systems can be divided into central systems and customer systems in order to reduce costs. Traditional franking systems such as, for example, sender franking machines that are not divided in this manner comprise mechanisms for securely producing postage indicia as well as a printing means for printing out these postage indicia. This division into a central system and a customer system makes it possible to operate the technically more complicated systems and methods for generating secure postage indicia for numerous customers and to only have the printing of the postage indicia done at the premises of the customer. A data network is employed between the central system and the customer system.

The production of postage indicia is a security-critical process. Since postage indicia have a monetary value, it is in the interest of the postal service provider to ensure that, during the production, valid postage indicia are only generated in those cases where their correct payment is assured.

For example, the use of cryptographic methods (e.g. encryption or digital signature) ensures that postage indicia cannot be forged. After all, when postage indicia are generated and when they are checked later on within the scope of the letter or parcel production, if cryptographic keys are used which have been agreed upon between the parties involved or from which the identity of these parties is unambiguously clear, then unauthorized third parties, who do not have the cryptographic key, do not have the possibility to forge postage indicia in such a way that they would be interpreted as valid postage indicia during the letter or parcel production.

When central systems are used, the postage indicia can be cryptographically secured especially effectively and at a high level. Since cryptographic franking processes are usually implemented in the form of special hardware and software (so-called “cryptographic modules”) in order to prevent manipulation, they can be operated at a central location with much less effort than if cryptographic modules were operated at the premises of the individual franking customers.

Measures to avoid the production of duplicates or so-called “doubles” of valid postage indicia prevent valid postage indicia from being used multiple times to send letters and parcels.

There are just as many diverse measures for suppressing doubles as there are franking methods. Whereas special inks and papers that largely prevent the production of identical doubles are used for analog postage indicia that are generated by printing procedures, in the case of digital franking procedures, non-manipulatable computer processes are used that prevent multiple print-outs (e.g. in the case of new franking machines).

When central franking systems are used, it is the printer of the customer system that normally prevents the generation of multiple print-outs. Once the central system has generated a cryptographically secured postage indicium and has transmitted it to the customer system, non-manipulatable computer processes in the customer system ensure that a postage indicium can only be printed out once and not multiple times.

An example of a central system for the production of postage indicia is the PC franking system of the German Postal System (Deutsche Post) called STAMPIT. STAMPIT consists of software called “STAMPIT Client”, which is installed on the PC of each STAMPIT customer, and of a central system called “STAMPIT Server”, which is operated in a computer center of the Deutsche Post. When a customer wishes to generate a postage indicium, a request is sent via a network connection from the STAMPIT Client to the STAMPIT Server. The latter generates the postage indicium as an electronic byte sequence in a cryptographically high-security area. After this byte sequence has been transmitted back from the STAMPIT Server to the STAMPIT Client, the cryptographically secured byte sequence is converted into a machine-readable barcode and this barcode is printed out together with other additional information to create a valid postage indicium. Non-manipulatable processes within the special software of the STAMPIT Client ensure that a valid postage indicium can only be printed out once. A multiple print-out of one and the same postage indicium is prevented by the STAMPIT Client.

Methods as well as devices to carry out such methods in such a way as to produce the most forgery-proof postage indicia possible have been disclosed in a number of patent applications and patents.

Thus, for example, DE 100 20 563 C2 relates to a method for the production of forgery-proof documents or data records using a security module, whereby the data security is enhanced in that the result of an irreversible linking of data introduced by the document producer—introduced data—is introduced together with encrypted information from an authentication unit.

DE 100 20 561 C2 discloses a security module for generating forgery-proof documents that is configured in such a way that it contains two combination machines, whereby one of the combination machines combines the output value of an identification register with the output value of a secret generator and whereby a second combination machine carries out a combination of a secret with entered input data.

It is also known that the Internet offers its users simple access to information conatents and services. For this purpose, a standard program named “browser” is employed on the PC of the user. This program allows the Internet user to call central services, so-called “web servers”, that are accessible via the Internet and to make use of their information contents or services. An advantageous aspect of this method is especially that, due to the standardization in the realm of the interfaces (e.g. HTML HyperTextMarkupLanguage) and of the protocols (e.g. http HyperTextTransferProtocol), data can be exchanged between any web servers and browsers, as a rule spontaneously and without any prior announcements or arrangements.

### SUMMARY OF THE INVENTION

The invention provides a method wherein the postage indicia can be generated in the simplest and quickest manner possible. Preferably, the most comprehensive possible protection against fraudulently generated postage indicia should be achieved.

According to the invention, the transmission of the postage indicium from the central system to the customer system takes place in two stages, whereby in a first stage, an invalid pre-print of the postage indicium is transmitted and then the valid postage indicium is transmitted to the central franking system by feeding it back to the central system, said feedback being controlled by the printing process.

An advantage here is that at least some of the method steps required for a franking procedure can be controlled centrally. The central control of part of the franking procedure employed in an especially preferred embodiment of the invention allows a flexible change of parameters of the franking, for example, the implementation of new security features on short notice or the realization of changed franking parameters, for example, relating to the selection of persons who are entitled to use the franking method or to invoice franking procedures.

It is especially advantageous to refine the invention in such a way that the customer system accesses functions and/or data of the central system.

In order to carry this out in an especially simple and practical manner, it is advantageous that, for the operation of the customer system, a program is used that can call at least one program that is running on the central system.

Advantageously, the method is carried out in such a way that a standard web browser is used in the customer system.

It is advantageous for the franking request to be transmitted from the customer system to the central system via a standardized transmission protocol.

It is advantageous for the central system to generate a valid postage indicium in response to the franking request and for the central franking system to convert the valid postage indicium into an invalid pre-print.

Moreover, it is advantageous for the central system to replace the valid postage indicium with an invalid pre-print.

It is advantageous for the central system to temporarily store the valid postage indicium in a temporary register and to then control the access to it.

Advantageously, the method is carried out in such a way that the customer system is given access to the invalid pre-print.

It is advantageous for the customer system to be provided with information that allows access to the temporary register containing the valid postage indicium.

Here, it is advantageous for the customer system to display the invalid pre-print as the result of the requested postage indicium.

Moreover, it is advantageous that, when a printing process is carried out in the customer system, feedback to the central system is established in such a way that the temporary register containing the valid postage indicium is accessed.

Furthermore, it is advantageous for the transmitted valid postage indicium not to be displayed in the customer system but rather to be immediately printed out.

In order to further enhance the data security, it is advantageous for the valid postage indicium to be generated in such a way that it contains the result of an irreversible linking of data.

Moreover, the resultant high data security can also be further improved in that the postage indicium contains the irreversible linking of data provided by the customer system with data of the central system (ZS).

An increase in the data security can also be achieved in that the valid postage indicium contains information about the franking date.

In order to enhance the security against manipulation, it is also advantageous for the valid postage indicium to contain information about the intended recipient of the mailpiece.

The invention also relates to a method for verifying the authenticity of mailpieces.

According to the invention, this method is carried out in such a way that the mailpieces are generated, and that the central system transmits information about the generated valid postage indicium to at least one verification center.

The invention also relates to a device for franking mailpieces comprising a central system and a customer system as well as an upstream system.

According to the invention, this device is configured in such a way that the upstream system contains a temporary register in which valid postage indicia can be stored.

An especially preferred embodiment of this device is characterized in that the upstream system has an interface that is configured in such a way that information stored in the temporary register can be transmitted directly to a printer connected to the customer system.

Additional advantages, special features and practical embodiments of the invention can be gleaned from the subordinate claims and from the presentation below of preferred embodiments making reference to the figure.

### DESCRIPTION OF THE DRAWING

The drawing shows the following:

FIG. 1 a schematic diagram of a flow chart of a preferred embodiment of the invention.

### DETAILED DESCRIPTION

The embodiment presented below is merely to be construed as an example.

In the depicted embodiment of the invention, the central system is connected to an upstream web server.

Here, it is especially advantageous for the upstream web server to fulfill the functions described below.

It is through the expansions that functionalities relating to the invention that fall outside of the area of the standard web technology (on the server side) are implemented. In contrast, no changes are made on the part of the web browser.

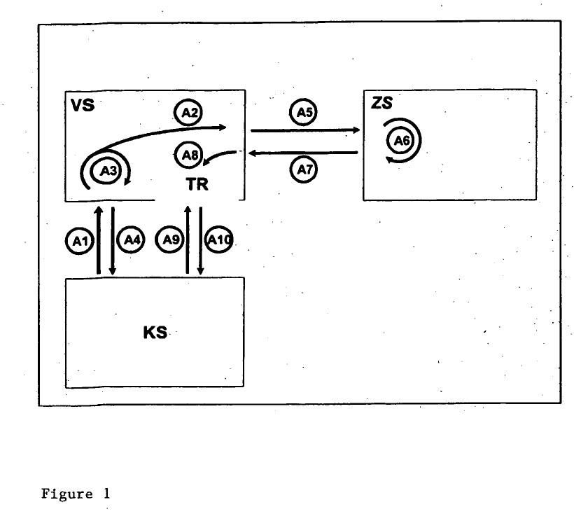

FIG. 1 shows an especially preferred embodiment of a two-stage process of requesting and transmitting postage indicia, as seen from the vantage point of the customer browser.

Using the franking system according to the invention, various advantageous embodiments of franking methods can be carried out.

The presentation below refers by way of example to especially advantageous ways of carrying out methods according to the invention. This is done making reference to the numerals of FIG. 1.

A customer uses an access program to request a postage indicium. Here, advantageously a franking request is transmitted from the customer system to the central system (A1).

This is done in an especially simple and reliable way in that the franking request is transmitted from the customer system to the central system by means of a standardized transmission protocol. The transmission protocol employed is, for example, HTML or XTML. This has the additional advantage that a standard web browser can be used by the customer system.

The central system generates a valid postage indicium. This postage indicium is advantageously processed in such a way that it is not accessible to the customer system during its generation and immediately thereafter. This has the advantage that, for the time being, no valid postage indicia can be generated using the customer system.

In an especially preferred embodiment, the postage indicium is generated immediately after a franking request has been received in the central system.

However, by the same token, it is possible in other, likewise advantageous embodiments, to uncouple the generation of the valid postage indicium from the franking request to a greater extent.

The request of a postage indicium as well as the subsequent process steps will be presented below by way of an example.

The franking request is checked and, after authentication, forwarded to the central system for purposes of generating a valid postage indicium (A2).

A central system configured in an especially preferred manner is presented below. This central system is configured in such a way that it can carry out process steps that are especially suitable for the franking system. Since it is particularly well-suited for generating postage indicia employing the STAMPIT method of the Deutsche Post, the server is also referred to below as the STAMPIT server.

Parallel to the processing of the postage indicium in the central system (STAMPIT server), the customer is preferably provided with a standard HTML page in response to his valid postage printing request (A3). Preferably, the suitable input interface, preferably a standard HTML page, is technically based on a so-called Cascading Style Sheet (CSS). “Cascading Style Sheets CSS” can be used on many of the newer standard browsers. They offer the possibility to “format” information content by specifying fonts, character size, positioning, etc. By using the CSS technology, it is possible to print postage indicia so uniformly and correctly that they are machine-readable within the scope of letter and parcel production. For the first stage of transmission (screen view) in question here, reference is made to the graphical representation of the invalid pre-print.

Unlike the standard CSS, the CSS being used here is created individually for each franking procedure and is stored on the web server. In addition to other formatting, it also contains the openly accessible address of the invalid pre-print that is to be displayed in the HTML browser view. It is important within the scope of the invention for the protection of access to the register of the valid postage indicium that is needed later in the second step for the print-out to be likewise integrated into the CSS in the form of a cryptographic session key.

The upstream web server transmits a data record to the customer system (A4). Preferably, the transmission is carried out in a standard HTML format. The formatting is specially defined individually for the franking, preferably by CSS.

Before, after or during the transmission of the invalid pre-print back to the customer, a request to generate a valid PC postage indicium is sent to the STAMPIT server. This request contains all of the information needed for generating a valid postage indicium, including the serial number of the customer, the authentication of the customer (PIN), the desired product and payment, the date of the franking and parts of the address of the recipient (A5).

The valid postage indicium is generated in the STAMPIT server (A6).

The data content of the machine-readable barcode of the postage indicium is transmitted back (A7).

The data content of the machine-readable barcode is converted into a printable graphical representation and temporarily stored in a temporary register (A8).

The previously generated cryptographic session key, which is integrated into the CSS individually used for the franking, ensures that the register can only be called one single time and only by the authenticated customer.

Once the postage indicium is printed out, the second stage of the web communication, which is not necessary in standard web technology, is started. According to the information that serves for accessing the valid postage indicium and that is stored in the CSS, a second connection to the web server is established in a way that is not visible to the customer (A9). On the basis of the cryptographic session key, the web server checks the authorization to access the valid postage indicium and issues it.

Unlike with standard web technology, the graphical representation of the valid postage indicium, the session key and the CSS are subsequently deleted from the web server. The access and the deletion are recorded.

The valid postage indicium is transmitted directly to the printer and printed out without being displayed in the browser (A10).

Variant 1:

In the procedure described above, the valid postage indicium is requested by the STAMPIT server at the earliest possible point in time (A2). As an alternative, it would be possible to wait until the feedback is provided by the print-out (above A9). In actual practice, the reason for the early request is for purposes of avoiding an additional waiting time for the customer after the start of the printing procedure.

Variant 2:

In the procedure described above, a graphical representation that is used for all customers is employed as the invalid pre-print of the postage indicium. As an alternative, it would be possible to wait with the transmission of the screen view (A4 above) until the valid postage indicium from the STAMPIT server is present. The valid postage indicium could then be rendered invalid for the screen view.

The changes to be undertaken in order to implement the central franking system described above pertain exclusively to the web server. This web server has to be expanded by functionalities for converting the data of a valid postage indicium supplied by the STAMPIT server into a printable graphical representation, by its temporary storage in a register and by the generation and storage of individual CSS's.

An especially preferred practical implementation of the invention provides for using the CSS's in such a way that, first of all, a distinction can be made between graphical representations that are displayed on the screen and those that are used in the print-out. For this purpose, expansions on the server side are needed in order to individually generate CSS's during a first communication step, to provide them with a cryptographic session key and to store them temporarily so as to allow access by the authorized user.

The invention discloses a number of advantageous embodiments for suppressing multiple print-outs of generated valid postage indicia, thus preventing a fraudulent generation of additional postage indicia.

Especially preferred embodiments of the invention also make it possible to utilize standard technologies in the realm of the customer system, so that the invention also allows conventional computers to access franking methods without a need for them to be specially equipped for this purpose.

However, it is, of course, possible to increase the data security by also modifying the customer systems.

Moreover, it is advantageous to provide the postage indicia with digital information that makes them even more forgery-proof.

Examples of this are described in the German patents DE 100 20 566, DE 100 20 402 and DE 100 56 599.

Reference is hereby made to the entire contents of the method steps disclosed in these publications for purposes of embedding encrypted digital data into postage indicia and to the method steps for verifying the authenticity of the generated postage indicia.

List of Reference Numerals

A1 request of a postage indicium by the customer system KS
A2 forwarding of the franking request to the central system ZS
A3 provision of an input interface
A4 transmission of a data record to the customer system KS
A5 franking request to the central server ZS with information for generating a valid postage indicium
A6 generation of the valid postage indicium
A7 transmission of the machine-readable postage indicium to the upstream server VS
A8 temporary storage of the data content of the postage indicium in a temporary register TR
A9 establishment of another connection from the customer system KS to the upstream web server
A10 transmission and print-out of the valid postage indicium
KS customer system
TR temporary register
VS upstream system
ZS central system

1. A method for franking mailpieces with a postage indicium, wherein the postage indicium is produced on a central system and transmitted to a customer system in order to be printed,
the method comprising the steps of
transmitting the postage indicium from the central system to the customer system in two stages, comprising in a first stage, transmitting an invalid pre-print of the postage indicium formatted by cascading style sheets (CSS) as well as a cryptographic session key integrated into the CSS and then in a second stage transmitting a valid postage indicium a single time to the customer system and authenticating the valid postage indicium on the basis of the cryptographic session key previously integrated into the CSS by feeding it back to the central system, controlling said feedback by the printing process, so that the postage indicium is not displayed in the customer system but rather is immediately printed out.

2. The method according to claim 1,
comprising centrally controlling
at least some of the method steps required for a franking procedure.

3. The method according to claim 1,
comprising
the customer system accessing functions and/or data of the central system.

4. The method according to claim 3,
for the operation of the customer system, using a program that can call at least one program that is running on the central system.

5. The method according to claim 4,
comprising using
a web browser to operate the customer system.

6. The method according to claim 5,
comprising transmitting
the franking request from the customer system to the central system via a standardized transmission protocol.

7. The method according to claim 1,
comprising
the central system first generating a valid postage indicium and the central system then converting the valid postage indicium into an invalid pre-print.

8. The method according to claim 1,
comprising
the central system generating a valid postage indicium and the central system replacing the valid postage indicium with an invalid pre-print.

9. The method according to claim 7,
comprising
the central system temporarily storing the valid postage indicium in a temporary register and controlling access to the temporary register.

10. The method according to claim 7,
comprising giving
the customer system access to the invalid pre-print.

11. The method according to claim 10,
comprising providing
the customer system with information that allows access to the temporary register containing the valid postage indicium.

12. The method according to claim 7,
comprising
the customer system displaying the invalid pre-print as the result of the requested postage indicium.

13. The method according to claim 9,
comprising
when a printing process is carried out in the customer system, establishing feed-back to the central system in such a way that the temporary register containing the valid postage indicium is accessed.

14. The method according to claim 1,
comprising generating
the valid postage indicium in such a way that it contains the result of an irreversible linking of data.

15. The method according to claim 14,
wherein
the postage indicium contains the irreversible linking of data provided by the customer system with data of the central system.

16. The method according to claim 1,
wherein
the valid postage indicium contains information about a franking date.

17. The method according to claim 1,
wherein
the valid postage indicium contains information about the intended recipient of the mailpiece.

18. A method for verifying the authenticity of mailpieces,
comprising generating
the postage indicium by a method according to claim 1, comprising deleting the graphical representations of the valid postage indicia from the central system after they have been accessed by the customer system, recording the access and the deletion and, the central system transmitting information about the generated valid postage indicia to at least one verification center.

19. A device for franking mailpieces comprising a central system and a customer system as well as an upstream system,
wherein
the upstream system contains a temporary register in which valid postage indicia can be stored as well as means to create cascading style sheets (CSS's) individually in a first communication step and to provide them with a cryptographic session key.

20. The device according to claim 19,
wherein
the upstream system has an interface that is configured in such a way that information stored in the temporary register can be transmitted directly to a printer connected to the customer system.
